(19) United States
(12) Patent Application Publication
(10) Pub. No.: US 2026/0203950 A1
(43) Pub. Date: Jul. 16, 2026

(54) LEARNING IN RAHT DOMAIN FOR POINT CLOUD ATTRIBUTE CODING

(71) Applicant: InterDigital VC Holdings, Inc., Wilmington, DE (US)

(72) Inventors: Muhammad Asad Lodhi, Highland Park, NJ (US); Jiahao Pang, Plainsboro, NJ (US); Junghyun Ahn, New York, NY (US); Dong Tian, Boxborough, MA (US)

(21) Appl. No.: 19/020,639

(22) Filed: Jan. 14, 2025

(51) Int. Cl. G06T 9/00; G06T 9/40

(52) U.S. Cl. CPC G06T 9/001; G06T 9/002; G06T 9/40

(57) ABSTRACT

Some embodiments of a method may include: decoding features representing Region-Adaptive Hierarchical Transform (RAHT) coefficients corresponding to a point cloud frame at a current resolution; reconstructing the RAHT coefficients corresponding to the point cloud frame at the current resolution; and performing a RAHT inverse transform based on the reconstructed RAHT coefficients. Some embodiments of a method may include: computing RAHT coefficients based on attributes from a child octree level; performing feature extraction based on the RAHT coefficients using a neural network module; generating a feature map; and encoding the current feature map into a bitstream.

### INCORPORATION BY REFERENCE

The present application incorporates by reference in their entirety the following applications: International Patent Application Serial No. PCT/US2022/046950, entitled “HYBRID FRAMEWORK FOR POINT CLOUD COMPRESSION” and filed Oct. 18, 2022 (“'950 application”); International Patent Application Serial No. PCT/US2022/052861, entitled “SCALABLE FRAMEWORK FOR POINT CLOUD COMPRESSION” and filed Dec. 14, 2022 (“'861 application”); and International Patent Application Serial No. PCT/US2023/034393, entitled “SPARSE TENSOR-BASED BITWISE DEEP OCTREE CODING” and filed Oct. 30, 2023 (“'393 application”), which claims priority to U.S. Provisional Patent Application Ser. No. 63/415,841 and filed Oct. 13, 2022 (“'841 application”).

### BACKGROUND

The present application is related to point clouds.

### SUMMARY

A first example method in accordance with some embodiments may include: decoding features representing Region-Adaptive Hierarchical Transform (RAHT) coefficients corresponding to a point cloud frame at a current resolution; reconstructing the RAHT coefficients corresponding to the point cloud frame at the current resolution; and performing a RAHT inverse transform based on the reconstructed RAHT coefficients.

For some embodiments of the first example method, performing the RAHT inverse transform includes: performing a RAHT inverse transform along a z-direction; performing a RAHT inverse transform along a y-direction; and performing a RAHT inverse transform along an x-direction.

For some embodiments of the first example method, performing the RAHT inverse transform along the z-direction generates 2 intermediate DC coefficients; performing the RAHT inverse transform along the y-direction generates 4 intermediate DC coefficients; and performing the RAHT inverse transform along then x-direction generates 8 intermediate DC coefficients.

For some embodiments of the first example method, reconstructing the RAHT coefficients generates only a DC RAHT coefficient at the current resolution.

For some embodiments of the first example method, reconstructing the RAHT coefficients generates only AC RAHT coefficients at the current resolution.

Some embodiments of the first example method may further include obtaining a DC RAHT coefficient from a parent level RAHT inverse transform.

For some embodiments of the first example method, performing the RAHT inverse transform includes performing a bottom-up procedure to determine weights for the RAHT inverse transform.

For some embodiments of the first example method, performing the RAHT inverse transform includes combining the RAHT coefficients at the current resolution level to produce a RAHT DC coefficient for a child level.

Some embodiments of the first example method may further include obtaining an encoded bitstream corresponding to the point cloud frame.

A first example apparatus in accordance with some embodiments may include: a processor; and a memory storing instructions operative, when executed by the processor, to cause the apparatus to: decode features representing RAHT coefficients corresponding to a point cloud frame at a current resolution; reconstruct the RAHT coefficients corresponding to the point cloud frame at the current resolution; and perform a RAHT inverse transform based on the reconstructed RAHT coefficients.

A second example method in accordance with some embodiments may include: computing RAHT coefficients based on attributes from a child octree level; performing feature extraction based on the RAHT coefficients using a neural network; generating a current feature map; and encoding the current feature map into a bitstream.

For some embodiments of the second example method, performing feature extraction includes: concatenating the RAHT coefficients; and performing a convolutional neural network (CNN) process on the concatenated RAHT coefficients to extract features.

For some embodiments of the second example method, concatenating the RAHT coefficients includes generating an 8-dimensional RAHT map at the current resolution.

For some embodiments of the second example method, concatenating the RAHT coefficients includes generating a RAHT map at a resolution level higher than the current resolution.

For some embodiments of the second example method, the concatenated RAHT coefficients are used for each voxel at the current resolution.

For some embodiments of the second example method, concatenating the RAHT coefficients includes skipping a RAHT DC coefficient and using only RAHT AC coefficients for concatenating the RAHT coefficients.

For some embodiments of the second example method, computing the RAHT coefficients includes performing a RAHT transform on a point cloud frame.

For some embodiments of the second example method, performing the RAHT transform includes: performing a RAHT transform along a z-direction; performing a RAHT transform along a y-direction; and performing a RAHT transform along an x-direction.

For some embodiments of the second example method, computing the RAHT coefficients generates only a DC RAHT coefficient at the current resolution.

For some embodiments of the second example method, computing the RAHT coefficients generates only AC RAHT coefficients at the current resolution.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1 is a system diagram illustrating an example set of interfaces for a system according to some embodiments.

FIG. 2 is a process diagram illustrating an example RAHT transform according to some embodiments.

FIG. 3 is a process diagram illustrating an example coding of RAHT coefficients according to some embodiments.

FIG. 4 is a process diagram illustrating an example learning-based attribute coding framework according to some embodiments.

FIG. 5 is a process diagram illustrating an example RAHT domain learning based attribute coding framework according to some embodiments.

FIG. 6 is a process diagram illustrating an example feature extractor with 8-dimensional single RAHT vector according to some embodiments.

FIG. 7 is a process diagram illustrating an example feature extractor with 7-dimensional single RAHT vector according to some embodiments.

FIG. 8 is a schematic perspective view illustrating an example spatial arrangement of repeated RAHT coefficients according to some embodiments.

FIG. 9 is a process diagram illustrating an example feature extractor with higher resolution arrangement of 8 RAHT vectors according to some embodiments.

FIG. 10 is a process diagram illustrating an example bottom-up procedure for calculating weights for a RAHT inverse transform according to some embodiments.

FIG. 11 is a process diagram illustrating an example RAHT inverse transform according to some embodiments.

FIG. 12 is a process diagram illustrating an example RAHT domain learning based attribute coding framework reconstructing only RAHT DC coefficients at each level according to some embodiments.

FIG. 13 is a flowchart illustrating an example decoding process according to some embodiments.

FIG. 14 is a flowchart illustrating an example encoding process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . .” For brevity and clarity of presentation, this implied leading clause is not repeated ad nauseum in the detailed description.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

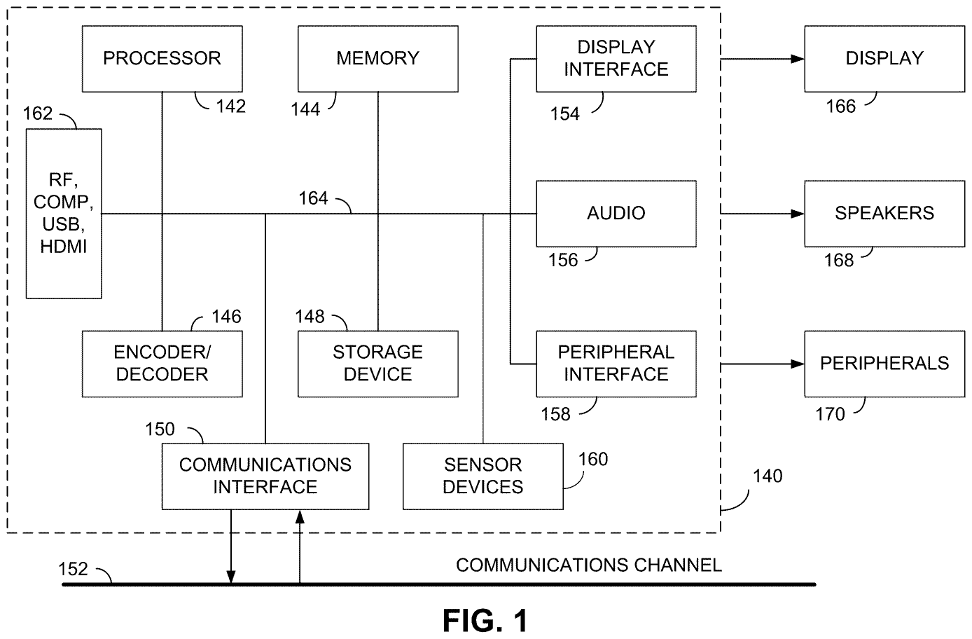

FIG. 1 is a system diagram illustrating an example set of interfaces for a system according to some embodiments. An extended reality display device, together with its control electronics, may be implemented using a system such as the system of FIG. 1. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (12C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

A User Equipment (UE) may correspond to any eXtended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

### Point Cloud Data Format

The field of point cloud compression and processing aims to develop tools for compression, analysis, interpolation, representation and understanding of input signals, such as point clouds.

Point cloud data is a universal data format across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats may be necessary for point cloud understanding and communication. In particular, raw point cloud data may be organized and processed for the purposes of world modeling and sensing. Compression of raw point clouds may be used when storage and transmission of the data are used in related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be handled in real-time or with low delay.

Each point of the point cloud may be represented by at least a 3D position (x, y, z). The set of 3D positions illustrates the geometry of the object/scene from which the point cloud is captured. Additionally, each point of the point cloud may be associated with some attributes, depending on the applications. For example, for VR/AR/Gaming, the attribute may include color (r, g, b), and for LiDAR, the attribute may include reflectance.

### Point Cloud Data Use Cases

The automotive industry and autonomous cars are domains in which point clouds may be used. Autonomous cars are able to “probe” their environment to make good driving decisions based on the reality of their immediate surroundings. Typical sensors, like LiDARs, produce (dynamic) point clouds that are used by the perception engine. These point clouds are not intended to be viewed by human eyes, and they are typically sparse, not necessarily colored, and dynamic with a high frequency of capture. They may have other attributes, like the reflectance ratio provided by the LiDAR because this attribute may be indicative of the material of the sensed object, and this attribute may be used in making a decision.

Virtual Reality (VR) and immersive worlds have become a hot topic and are foreseen by many as the future of 2D flat video. The viewer is immersed in an environment all around the viewer as opposed to standard TV in which the viewer may look only at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as cultural heritage/buildings in which objects, like statues or buildings, are scanned in 3D to share the spatial configuration of the object without sending or visiting the statues or buildings. Also, point clouds offer a way to ensure preservation of the knowledge of the object in case the original object, for instance, is destroyed by an earthquake. Such point clouds are typically static, colored, and huge.

Another use case is in topography and cartography in which, when using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

3D point cloud data include discrete samples of the surfaces of objects or scenes. A huge number of points may be used to fully represent the real world with point samples. For instance, a typical VR immersive scene may contain millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for processing or inference on a point cloud is to have efficient storage methodologies. To store and process the input point cloud with affordable computational cost, the point cloud may be down-sampled first, in which the down-sampled point cloud summarizes the geometry of the input point cloud while having much fewer points. The down-sampled point cloud may be inputted into a machine task for further processing. However, further reduction in storage space may be achieved by converting the raw point cloud data (original or down-sampled) into a bitstream through entropy coding techniques for lossless compression.

In addition to lossless coding, many scenarios may use lossy coding for significantly improved compression ratios while maintaining the induced distortion under certain quality levels. To achieve a less lossy coding, an efficient point feature extractor may be used to improve the accuracy of the reconstruction within the given resource budget.

### Learning-Based Point Cloud Compression

Since point cloud data is composed of two components: geometry info and attribute info, the compression of point clouds may be classified into two categories: geometry coding and attribute coding.

Compared to learning-based point cloud geometry coding, learning-based point cloud attribute coding is less developed. A higher compression ratio with a light-weight design is desired for learning-based attribute coding. A typical existing learning-based point cloud attribute compression relies on attribute features directly extracted from the original attribute domain. For example, for color attributes, the feature extraction begins with RGB data or YUV data. For reflectance attributes, the feature is extracted directly based on the reflectance data.

Point clouds may impose great challenges when being stored or transmitted due to a huge amount of data. This challenge may be due to the coding of both point cloud geometry information and point cloud attribute data. The present application tackles the challenges in learning-based point cloud attribute compression and discusses how to perform attribute coding using deep learning techniques assuming that the corresponding geometry information has already been encoded or decoded. The major challenge is how to perform feature extraction and aggregation of attributes. The present application codes the attribute features efficiently for some embodiments.

### Learning in Transform Domain

Many learning technologies are conducting feature extraction in their input data domain, e.g., pixel domain in use for learning on image/video, point domain in use for learning on point clouds. There exist, however, other attempts to learn in the transform domain instead of the input data domain.

For example, the DCT domain may be used to facilitate a learning pipeline, such as the one in Ghosh, Arthita, and Rama Chellappa, Deep Feature Extraction in the DCT Domain, 2016 23RD INTERNATIONAL CONF. ON PATTERN RECOGNITION (ICPR) 3536-3541, IEEE (2016) (“Ghosh”), for various image classification tasks such as pedestrian and face detection, material identification and object recognition. More generally, article Xu, Kai, et. al., Learning in the Frequency Domain, PROCEEDINGS OF THE IEEE/CVF CONF. ON COMP. VISION AND PATTERN RECOGNITION 1740-1749 (2020) (“Xu”) conducted learning in the frequency domain for improved ImageNet classification and instance segmentation tasks.

This application discusses a learning-based point cloud attribute coding in RAHT (Region-Adaptive Hierarchical Transform) domain for some embodiments. See de Queiroz, Ricardo and Philip A. Chou, Compression of 3D Point Clouds Using a Region-Adaptive Hierarchical Transform, 25:8 IEEE TRANS. ON IMAGE PROCESSING 3947-3956 (2016) (“de Queiroz”) regarding the RAHT domain.

The point cloud geometry is assumed to have been encoded with a reconstructed point cloud geometry being produced. The encoder performs a “recoloring” procedure to “transfer” the attribute information from the original point cloud frame to the reconstructed point cloud geometry. The “recoloring” procedure is necessary since the coded point cloud geometry typically undergoes certain distortions, which leads to the attributes for the reconstructed points being undefined. After the reconstructed point cloud geometry is filled up by attributes, the reconstructed point cloud is sent to an attribute encoder to code the attributes. The RAHT-based method is a non-learning-based method to encode the attributes.

The RAHT transform processes the point cloud attributes along the octree structure of the point cloud frame. Since the present application is dedicated to attribute coding, the octree is assumed available to be referenced since the octree represents the point cloud geometry. The voxel at the root level represents the whole space from which the point cloud is sampled. Each occupied octree voxel is subdivided recursively into 8 equally-sized child voxels.

### RAHT/Learning-Based Encoding

The RAHT-based attribute encoding method involves a 2-pass procedure: the first pass is a bottom-up procedure for the RAHT transform, and the second pass is a top-down procedure for encoding.

### RAHT Transform

The RAHT transform is performed along an octree structure of a point cloud. The RAHT transform starts by accessing the attribute at the finest octree level and repeats by accessing the attribute(s) for each successive octree level.

Attributes at the finest octree level are filled through a recoloring process, which was mentioned earlier. For each occupied voxel in the finest octree level, a weight value of 1 is assigned. For each empty voxel in the finest octree level, a weight value of 0 is assigned.

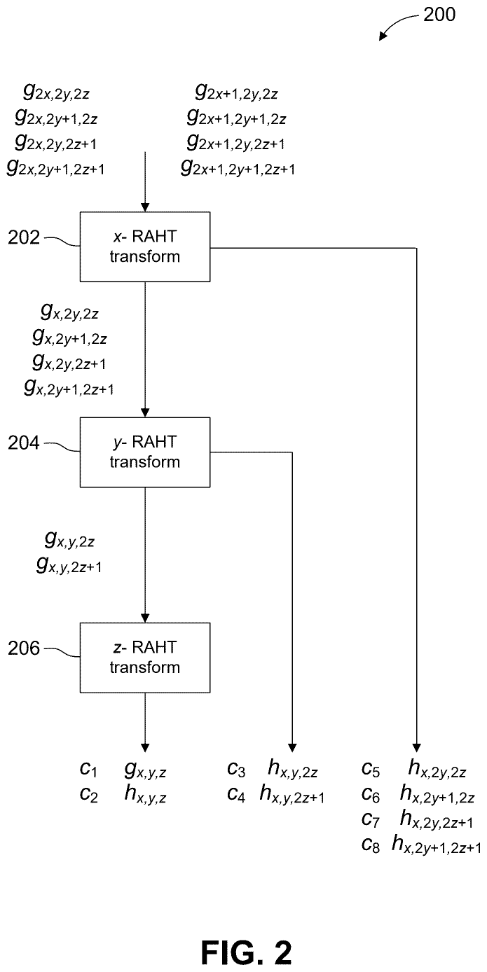

FIG. 2 is a process diagram illustrating an example RAHT transform according to some embodiments. FIG. 2 illustrates how a RAHT transform process 200 is performed for each octree level. Three steps are applied to each occupied voxel at (x, y, z) from a current coarser octree level. The input to the RAHT transform for each octree level is composed of the attribute values from the parent octree level. They are also referenced as DC coefficients for the 8 child voxels in this application:

$${g}_{2 x , 2 y , 2 z} , {g}_{2 x + 1 , 2 y , 2 z} , {g}_{2 x , 2 y + 1 , 2 z} , {g}_{2 x + 1 , 2 y + 1 , 2 z} ,$$

$${g}_{2 x , 2 y , 2 z + 1} , {g}_{2 x + 1 , 2 y , 2 z + 1} , {g}_{2 x , 2 y + 1 , 2 z + 1} , {g}_{2 x + 1 , 2 y + 1 , 2 z + 1}$$

The subscripts indicate the positions of the child voxel at the finer octree level. For example, subscript (2x, 2y+1, 2z) is a child voxel at (0,1,0). Additional input includes a list of weights (not shown in FIG. 2):

$${w}_{2 x , 2 y , 2 z} , {w}_{2 x + 1 , 2 y , 2 z} , {w}_{2 x , 2 y + 1 , 2 z} , {w}_{2 x + 1 , 2 y + 1 , 2 z} ,$$

$${w}_{2 x , 2 y , 2 z + 1} , {w}_{2 x + 1 , 2 y , 2 z + 1} , {w}_{2 x , 2 y + 1 , 2 z + 1} , {w}_{2 x + 1 , 2 y + 1 , 2 z + 1}$$

Step 1 (202) is an x-RAHT transform along x-direction. The following 4 pairs of weights are used:

$$( {w}_{1} , {w}_{2} ) = ( {w}_{2 x , 2 y , 2 z} , {w}_{2 x + 1 , 2 y , 2 z} )$$

$$( {w}_{1} , {w}_{2} ) = ( {w}_{2 x , 2 y + 1 , 2 z} , {w}_{2 x + 1 , 2 y + 1 , 2 z} )$$

$$( {w}_{1} , {w}_{2} ) = ( {w}_{2 x , 2 y , 2 z + 1} , {w}_{2 x + 1 , 2 y , 2 z + 1} )$$

$$( {w}_{1} , {w}_{2} ) = ( {w}_{2 x , 2 y + 1 , 2 z + 1} , {w}_{2 x + 1 , 2 y + 1 , 2 z + 1} )$$

Four pairs of transforms G and H are prepared:

$$[ \begin{matrix}G \\ H\end{matrix} ] = \frac{1}{\sqrt{{w}_{1} + {w}_{2}}} [ \begin{matrix}\sqrt{{w}_{1}} & \sqrt{{w}_{2}} \\ - \sqrt{{w}_{2}} & \sqrt{{w}_{1}}\end{matrix} ]$$

Four DC coefficients are computed as shown below:

$${g}_{x , 2 y , 2 z} = {G}_{x , 2 y , 2 z} ( {g}_{2 x , 2 y , 2 z} , {g}_{2 x + 1 , 2 y , 2 z} )$$

$${g}_{x , 2 y + 1 , 2 z} = {G}_{x , 2 y + 1 , 2 z} ( {g}_{2 x , 2 y + 1 , 2 z} , {g}_{2 x + 1 , 2 y + 1 , 2 z} )$$

$${g}_{x , 2 y , 2 z + 1} = {G}_{x , 2 y , 2 z + 1} ( {g}_{2 x , 2 y , 2 z + 1} , {g}_{2 x + 1 , 2 y , 2 z + 1} )$$

$${g}_{x , 2 y + 1 , 2 z + 1} = {G}_{x , 2 y + 1 , 2 z + 1} ( {g}_{2 x , 2 y + 1 , 2 z + 1} , {g}_{2 x + 1 , 2 y + 1 , 2 z + 1} )$$

Four AC coefficients are computed along the x-direction as part of the output of the RAHT transform at the current octree level:

$${h}_{x , 2 y , 2 z} = {H}_{x , 2 y , 2 z} ( {g}_{2 x , 2 y , 2 z} , {g}_{2 x + 1 , 2 y , 2 z} ) = {c}_{5}$$

$${h}_{x , 2 y + 1 , 2 z} = {H}_{x , 2 y + 1 , 2 z} ( {g}_{2 x , 2 y + 1 , 2 z} , {g}_{2 x + 1 , 2 y + 1 , 2 z} ) = {c}_{6}$$

$${h}_{x , 2 y , 2 z + 1} = {H}_{x , 2 y , 2 z + 1} ( {g}_{2 x , 2 y , 2 z + 1} , {g}_{2 x + 1 , 2 y , 2 z + 1} ) = {c}_{7}$$

$${h}_{x , 2 y + 1 , 2 z + 1} = {H}_{x , 2 y + 1 , 2 z + 1} ( {g}_{2 x , 2 y + 1 , 2 z + 1} , {g}_{2 x + 1 , 2 y + 1 , 2 z + 1} ) = {c}_{8}$$

Step 2 (204) is a y-RAHT transform along y-direction. The following 4 weights are used:

$${w}_{x , 2 y , 2 z} = {w}_{2 x , 2 y , 2 z} + {w}_{2 x + 1 , 2 y , 2 z}$$

$${w}_{x , 2 y + 1 , 2 z} = {w}_{2 x , 2 y + 1 , 2 z} + {w}_{2 x + 1 , 2 y + 1 , 2 z}$$

$${w}_{x , 2 y , 2 z + 1} = {w}_{2 x , 2 y , 2 z + 1} + {w}_{2 x + 1 , 2 y , 2 z + 1}$$

$${w}_{x , 2 y + 1 , 2 z + 1} = {w}_{2 x , 2 y + 1 , 2 z + 1} + {w}_{2 x + 1 , 2 y + 1 , 2 z + 1}$$

The four weights are paired as two pairs of weights as shown below:

$$( {w}_{1} , {w}_{2} ) = ( {w}_{x , 2 y , 2 z} , {w}_{x , 2 y + 1 , 2 z} )$$

$$( {w}_{1} , {w}_{2} ) = ( {w}_{x , 2 y , 2 z + 1} , {w}_{x , 2 y + 1 , 2 z + 1} )$$

Two pairs of transforms G and H are prepared:

$$[ \begin{matrix}G \\ H\end{matrix} ] = \frac{1}{\sqrt{{w}_{1} + {w}_{2}}} [ \begin{matrix}\sqrt{{w}_{1}} & \sqrt{{w}_{2}} \\ - \sqrt{{w}_{2}} & \sqrt{{w}_{1}}\end{matrix} ]$$

Two DC coefficients are computed along the y-direction as shown below:

$${g}_{x , y , 2 z} = {G}_{x , y , 2 z} ( {g}_{x , 2 y , 2 z} , {g}_{x , 2 y + 1 , 2 z} )$$

$${g}_{x , y , 2 z + 1} = {G}_{x , y , 2 z + 1} ( {g}_{x , 2 y , 2 z + 1} , {g}_{x , 2 y + 1 , 2 z + 1} )$$

Two AC coefficients are computed along the y-direction as part of the output of the RAHT transform at the current octree level:

$${h}_{x , y , 2 z} = {H}_{x , y , 2 z} ( {g}_{x , 2 y , 2 z} , {g}_{x , 2 y + 1 , 2 z} ) = {c}_{3}$$

$${h}_{x , y , 2 z + 1} = {H}_{x , y , 2 z + 1} ( {g}_{x , 2 y , 2 z + 1} , {g}_{x , 2 y + 1 , 2 z + 1} ) = {c}_{4}$$

Step 3 (206) is a z-RAHT transform along z-direction. The following 2 weights are used:

$${w}_{x , y , 2 x} = {w}_{x , 2 y , 2 z} + {w}_{x , 2 y + 1 , 2 z}$$

$${w}_{x , y , 2 z + 1} = {w}_{x , 2 y , 2 z + 1} + {w}_{x , 2 y + 1 , 2 z + 1}$$

The two weights form a pair of weights as shown below:

$$( {w}_{1} , {w}_{2} ) = ( {w}_{x , y , 2 z} , {w}_{x , y , 2 z + 1} )$$

A pair of transforms G and H are prepared:

$$[ \begin{matrix}G \\ H\end{matrix} ] = \frac{1}{\sqrt{{w}_{1} + {w}_{2}}} [ \begin{matrix}\sqrt{{w}_{1}} & \sqrt{{w}_{2}} \\ - \sqrt{{w}_{2}} & \sqrt{{w}_{1}}\end{matrix} ]$$

A DC coefficient is computed along the z-direction as part of the output of RAHT transform at the current octree level:

$${g}_{x , y , z} = {G}_{x , y , z} ( {g}_{x , y , 2 z} , {g}_{x , y , 2 z + 1} ) = {c}_{1}$$

An AC coefficient is also computed along the z-direction as part of the output of RAHT transform at the current octree level:

$${h}_{x , y , z} = {H}_{x , y , z} ( {g}_{x , y , 2 z} , {g}_{x , y , 2 z + 1} ) = {c}_{2}$$

To run the RAHT transform for the next octree level, the weight is computed as shown below:

$${w}_{x , y , z} = {w}_{x , y , 2 z} + {w}_{x , y , 2 z + 1}$$

For a voxel, the RAHT transform outputs 7 AC coefficients and 1 DC coefficient, which are: h_{x,2y,2z}, h_{x,2y+1,2z}, h_{x,2y,2z+1}, h_{x,2y+1,2z+1}, h_{x,y,2z}, h_{x,y,2z+1}, h_{x,y,z}, and g_{x,y,z}.

### Encoding

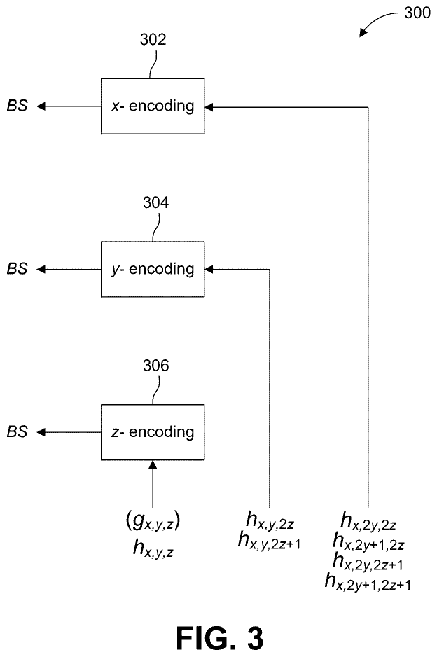

FIG. 3 is a process diagram illustrating an example coding of RAHT coefficients according to some embodiments. After the bottom-up RAHT transform is conducted on the whole octree structure, the RAHT transform coefficients are encoded via an encoding process 300 to generate bitstreams for the x, y, and z directions.

First, we present a basic encoding embodiment that starts from the root voxel, and it is iterated for all octree levels as shown in FIG. 3. For the root voxel, 1 DC coefficient g and 7 AC coefficients h are encoded. For voxels in remaining octree levels, 7 AC coefficients are encoded. Each encoding block 302, 304, 306 in FIG. 3 is composed of a quantization step and an arithmetic encoding step. The encoding corresponds to a traditional RAHT-based encoding for some embodiments.

### High-Level Learning-Based Point Cloud Attribute Encoder

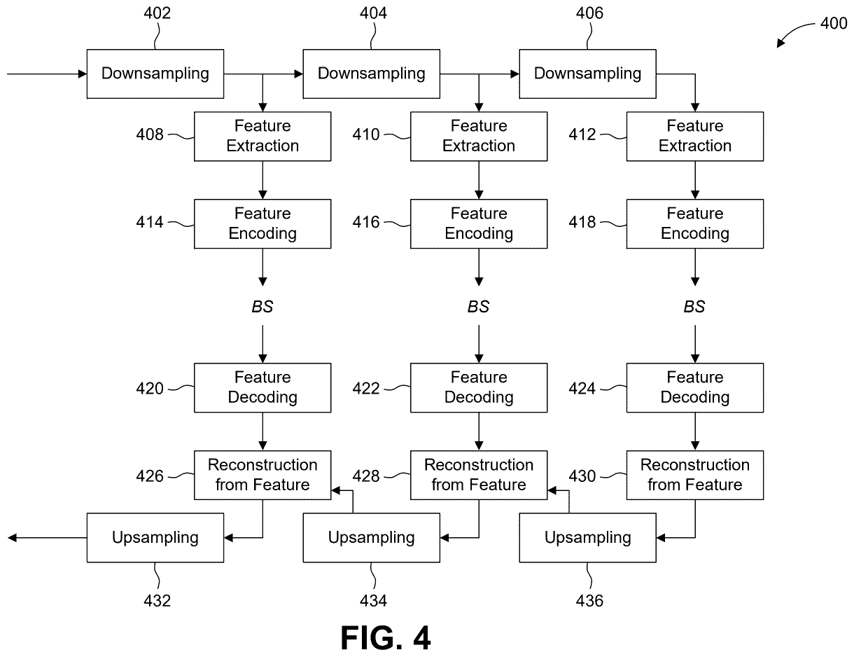

FIG. 4 is a process diagram illustrating an example learning-based attribute coding framework according to some embodiments. A high-level learning-based point cloud attribute encoder is shown in the top part of the example process 400 of FIG. 4. The encoder sends coded bitstreams at some octree levels. In some embodiments, a bitstream is produced for every octree level.

The diagram has a sequence of “downsampling” blocks 402, 404, 406 that represent the process to construct the octree structure of a point cloud. Point cloud attributes are assigned for voxels at each octree level. The output of each “downsampling” block 402, 404, 406 provides a point cloud frame at a lower resolution with half resolution at each direction of (x, y, z) comparing to its child octree level.

The “feature extraction” blocks 408, 410, 412 represent neural network blocks that extract features from the point cloud attributes. For some embodiments, the point cloud attributes in RGB color or YUV color serve as an input to the “feature extraction” blocks 408, 410, 412. The “feature extraction” blocks 408, 410, 412 output a set of features. The “feature encoder” blocks 414, 416, 418 perform an encoding process and generate a bitstream representing the received features.

### High-Level Learning-Based Point Cloud Attribute Decoder

The next section describes the overall decoding architecture in a learning-based point cloud attribute decoder.

A high-level learning-based point cloud attribute encoder is shown in the bottom part of FIG. 4. The decoder decodes the bitstreams for some octree levels. In some embodiments, a bitstream is decoded for every octree level.

The “feature decoder” blocks 420, 422, 424 perform a decoding process to decode a bitstream and produce quantized features representing the current octree level.

The “reconstruction from feature” blocks 426, 428, 430 in FIG. 4 represent a neural network blocks that enhance the decoded features for a current level and then produce a reconstruction of the current level point cloud attributes.

The diagram has a sequence of “upsampling” blocks 432, 434, 436 that aim to upsample the attribute reconstruction of the current octree level to the resolution of the child octree level, given that the geometry of the point cloud is already known. The output of each “upsampling” block provides a point cloud frame at a higher resolution with double resolution at each direction of (x, y, z).

Stated differently, the “feature decoder” blocks 420, 422, 424 perform a decoding process on the received bitstream. The outputs of the feature decoder blocks 420, 422, 424 are passed to reconstruction from feature blocks 426, 428, 430. The outputs of the reconstruction from feature blocks 426, 428, 430 are passed through upsampling blocks 432, 434, 436. The upsampling output from one level down in the octree structure is also an input into the reconstruction from feature blocks 426, 428, 430. The output of the top level upsampling block 432 is the reconstructed point cloud for some embodiments.

For some embodiments, the decoded features and the reconstruction represent the attribute information in the original domain, for example RGB color domain or YUV color domain in the case of VR/AR/Gaming applications, or the reflectance intensive value domain in the case of LiDAR applications. In the present application, features are decoded and reconstructed in the RAHT domain.

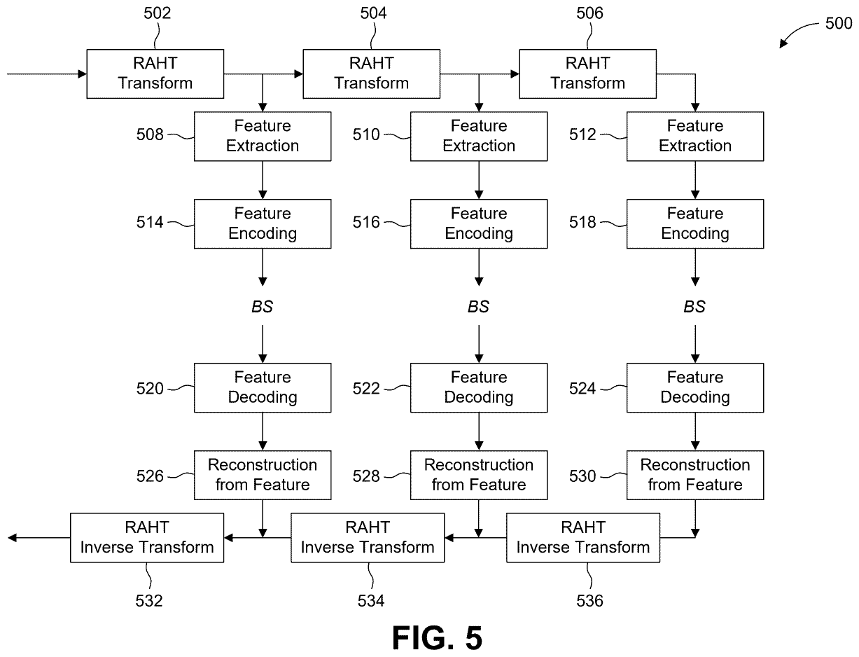

FIG. 5 is a process diagram illustrating an example RAHT domain learning based attribute coding framework according to some embodiments. For some embodiments, the features are extracted in original attribute domain, for example RGB color domain or YUV color domain in case of VR/AR/Gaming application, or reflectance intensive value domain in case of LiDAR applications. Features may be extracted in RAHT domain for some embodiments. The learning in the RAHT domain is illustrated in the top part of example process 500 of FIG. 5.

For some embodiments, the “downsampling” blocks 402, 404, 406 in FIG. 4 are replaced by “RAHT Transform” blocks 502, 504, 506 in FIG. 5. The “feature extraction” blocks 508, 510, 512 represent neural network blocks that extract features from the point cloud attributes. The “feature extraction” blocks 508, 510, 512 output a set of features. The “feature encoder” blocks 514, 516, 518 perform an encoding process and generate a bitstream representing the received features.

A learning-based decoding in RAHT domain is illustrated in the bottom part of FIG. 5. The “upsampling” blocks 432, 434, 436 in FIG. 4 are replaced by “RAHT Inverse Transform” blocks 532, 534, 536 in FIG. 5. The RAHT inverse transform is conducted for each octree level as described above. In FIG. 5, the “RAHT Inverse Transform” blocks 532, 534, 536 at a current level take as inputs the AC RAHT coefficients output from the “Reconstruction from Feature” blocks 526, 528, 530 and the DC RAHT coefficients output from the previous “RAHT Inverse Transform” block 532, 534, 536 and output the DC RAHT coefficients for the next level.

Stated differently, the “feature decoder” blocks 520, 522, 524 perform a decoding process on the received bitstream. The outputs of the feature decoder blocks 520, 522, 524 are passed to reconstruction from feature blocks 526, 528, 530. The outputs of the reconstruction from feature blocks 526, 528, 530 are passed through RAHT inverse transform blocks 532, 534, 536. The output of the top level RAHT inverse transform block 532 is the reconstructed point cloud for some embodiments.

### Feature Extraction in RAHT Domain

The description below describes how the “feature extraction” is designed based on the RAHT transform. Some embodiments for the “feature extraction” in FIG. 5 are also described.

Embodiments with Single RAHT Vector

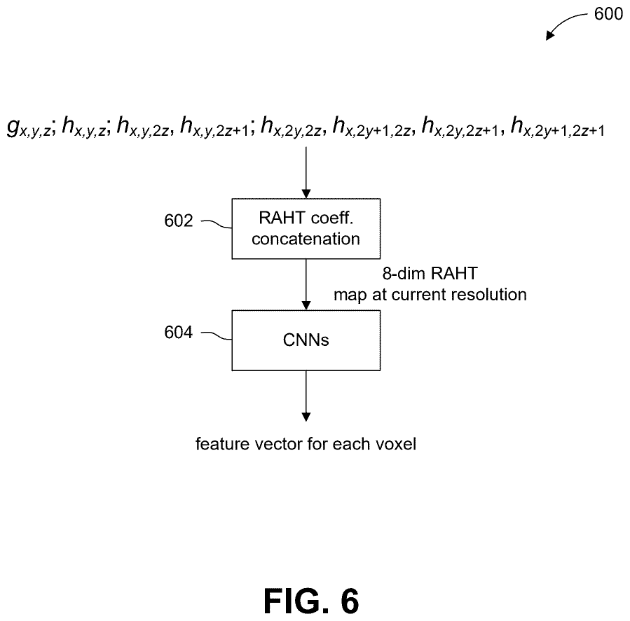

FIG. 6 is a process diagram illustrating an example feature extractor with 8-dimensional single RAHT vector according to some embodiments. In some embodiments, as shown in FIG. 6, a RAHT coefficient concatenation process 602 may be performed at the beginning of an example feature extraction process 600. That is, for each voxel at the current octree level, an 8-dimensional RAHT vector is composed by concatenating all the 8 RAHT coefficients together. Then, a CNN-based or sparse CNN-based neural network block 604 follows to extract features based on the RAHT vectors.

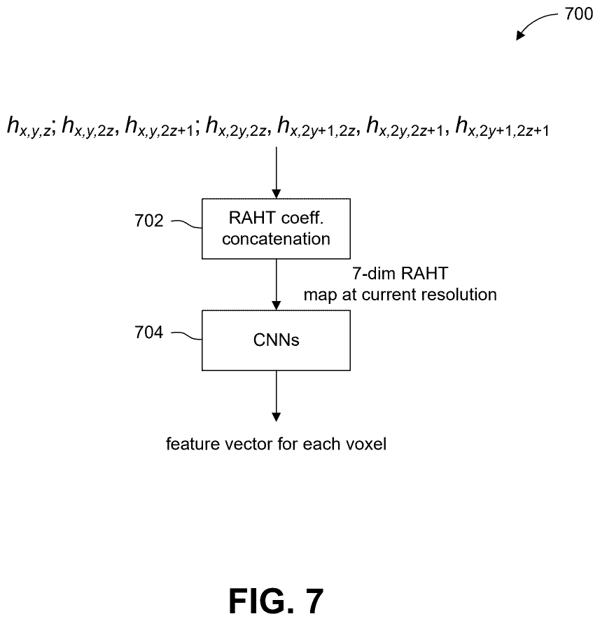

FIG. 7 is a process diagram illustrating an example feature extractor with 7-dimensional single RAHT vector according to some embodiments. In some embodiments, the RAHT DC coefficient is skipped when composing the RAHT vector. The DC coefficient may be skipped, for some embodiments of the feature extractor 700, because, during the RAHT inverse transform, the DC coefficient may be derived from a parent octree level. More description on RAHT inverse transform is given later. Removing the DC coefficient from the feature extraction forces the neural network block 704 to focus on characteristics in RAHT AC coefficients. This process is shown in FIG. 7, which is modified from FIG. 6. A RAHT coefficient concatenation process 702 may still be performed at the beginning of an example feature extraction process 700.

Embodiment with 8 RAHT Vectors

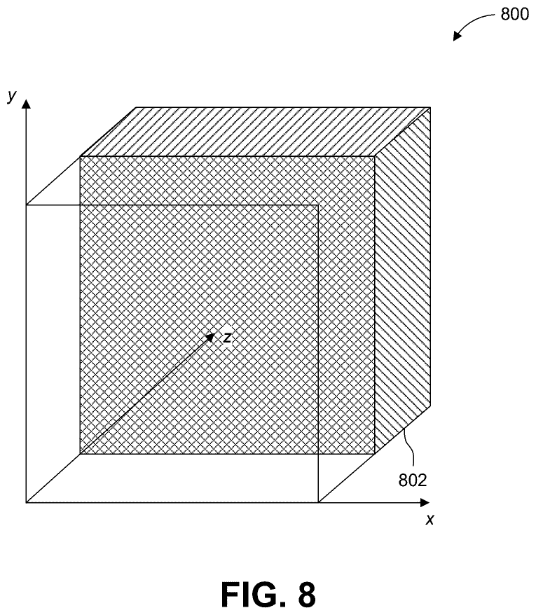

FIG. 8 is a schematic perspective view illustrating an example spatial arrangement of repeated RAHT coefficients according to some embodiments. In some embodiments, such as the processes shown in FIGS. 6 and 7, each voxel is comprised of a single RAHT vector. Such a method treats all RAHT coefficients uniformly and leaves out the spatial context information of each RAHT coefficient. By looking at the RAHT transform procedure, different RAHT coefficients may span different spatial spaces. For example, RAHT coefficient h_{x,y,2z+1} from the y-RAHT transform step occupies the space spanned by 4 sub-voxels in the farther part 802 of the voxel 800 shown in FIG. 8.

To keep the spatial information of each RAHT coefficient the same as inputted into a neural network block, some embodiments set a RAHT vector for each child voxel belonging to a current voxel. In total, there are 8 RAHT vectors for the current voxel.

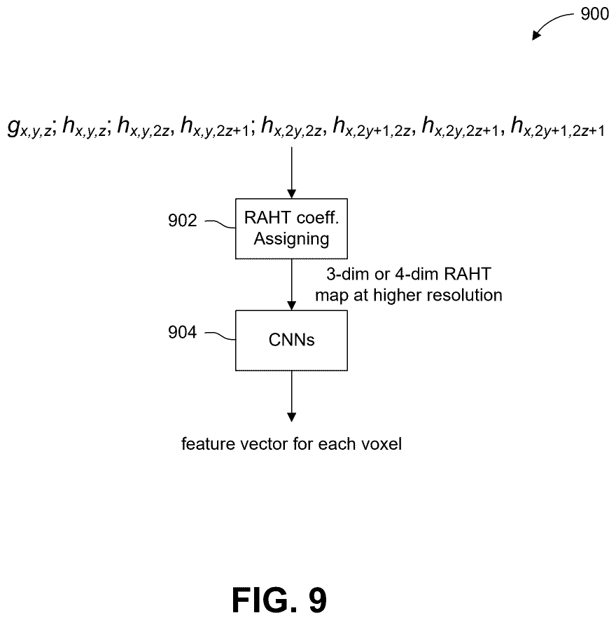

FIG. 9 is a process diagram illustrating an example feature extractor with higher resolution arrangement of 8 RAHT vectors according to some embodiments.

For each of the 8 child voxels, RAHT coefficients are assigned as if the RAHT coefficients are for the space of the corresponding child voxel. In other words, a RAHT coefficient is duplicated for all child voxels if the RAHT coefficient spans the corresponding space. To simplify the presentation, the DC coefficient (g_{x,y,z}) and the 7 AC coefficients (h_{x,y,z}, h_{x,y,2z}, h_{x,y,2z+1}, h_{x,2y,2z}, h_{x,2y+1,2z}, h_{x,2y,2z+1}, h_{x,2y+1,2z+1}) are represented as cᵢ, i=1, 2, 3, . . . , 8, respectively. The RAHT vector for each voxel is a 4-dimensional vector as shown below for some embodiments if both the DC coefficient and the AC coefficients are counted:
Child voxel at (0,0,0): c₁, c₂, c₃, c₅
Child voxel at (0,0,1): c₁, c₂, c₄, c₇
Child voxel at (0,1,0): c₁, c₂, c₃, c₆
Child voxel at (0,1,1): c₁, c₂, c₄, c₈
Child voxel at (1,0,0): c₁, c₂, c₃, c₅
Child voxel at (1,0,1): c₁, c₂, c₄, c₇
Child voxel at (1,1,0): c₁, c₂, c₃, c₆
Child voxel at (1,1,1): c₁, c₂, c₄, c₈

The above process corresponds to the RAHT Coefficient Assigning block 902 in FIG. 9. By setting the 8 RAHT vectors, each RAHT coefficient is associated with a spatial position. This observation allows the neural network 904 to count the spatial information as context when extracting features. In some embodiments of the feature extractor process 900, if the DC coefficient is skipped to focus on AC coefficients, the RAHT vectors become 3-dimensional vectors.

The CNN block 604 in FIG. 6 takes a RAHT vector at the resolution of a current octree level, while the CNN block 904 in FIG. 9 takes a RAHT vector at the resolution of the child octree level. The output of the CNN block 604, 904 in both FIG. 6 and FIG. 9 is a feature map at the resolution of current octree level.

### RAHT/Learning-Based Decoding

The RAHT-based attribute decoding method is also a 2-pass procedure: a first bottom-up procedure to compute the RAHT weights based on the geometry information and a second top-down procedure to decode interleaved components with an RAHT inverse transform that starts from the root voxel of the octree.

### RAHT Inverse Transform and RAHT Weight Calculation

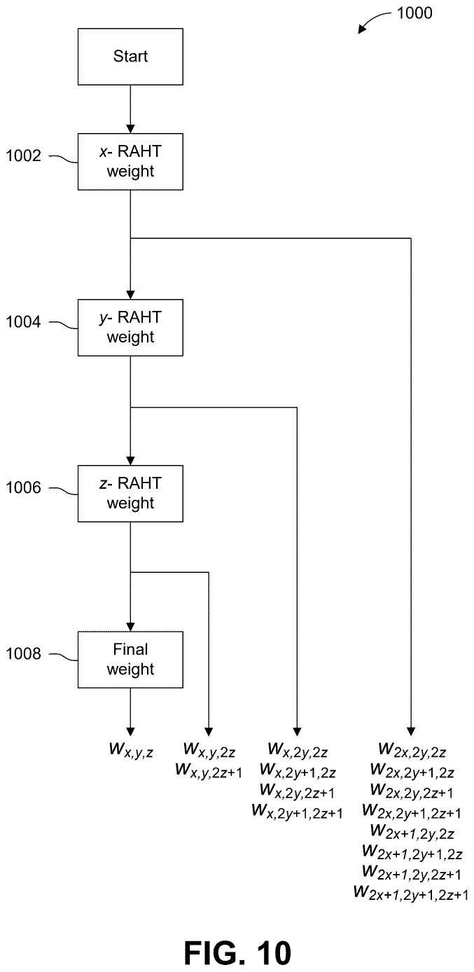

FIG. 10 is a process diagram illustrating an example bottom-up procedure for calculating weights for a RAHT inverse transform according to some embodiments.

In the first pass, a bottom-up procedure is used to calculate the weights used for making the RAHT inverse transform matrices. Since the geometry has already been decoded and known, the weights required for RAHT inverse transform are obtained through the voxel occupancy information, similar to the process used during encoding.

The following process 1000 starts with the leaf voxels towards the root voxel in a bottom-up fashion to calculate all the weights and the corresponding inverse transform matrices as shown in FIG. 10. The input to the weight calculations for each octree level includes a list of weights:

$${w}_{2 x , 2 y , 2 z} , {w}_{2 x + 1 , 2 y , 2 z} , {w}_{2 x , 2 y + 1 , 2 z} , {w}_{2 x + 1 , 2 y + 1 , 2 z} ,$$

$${w}_{2 x , 2 y , 2 z + 1} , {w}_{2 x + 1 , 2 y , 2 z + 1} , {w}_{2 x , 2 y + 1 , 2 z + 1} , {w}_{2 x + 1 , 2 y + 1 , 2 z + 1}$$

Step 1 (1002) prepares RAHT weight pairs along the x-direction for the RAHT and RAHT inverse transforms. The following 4 pairs of weights are obtained from the child voxels:

$$( {w}_{1} , {w}_{2} ) = ( {w}_{2 x , 2 y , 2 z} , {w}_{2 x + 1 , 2 y , 2 z} )$$

$$( {w}_{1} , {w}_{2} ) = ( {w}_{2 x , 2 y + 1 , 2 z} , {w}_{2 x + 1 , 2 y + 1 , 2 z} )$$

$$( {w}_{1} , {w}_{2} ) = ( {w}_{2 x , 2 y , 2 z + 1} , {w}_{2 x + 1 , 2 y , 2 z + 1} )$$

$$( {w}_{1} , {w}_{2} ) = ( {w}_{2 x , 2 y + 1 , 2 z + 1} , {w}_{2 x + 1 , 2 y + 1 , 2 z + 1} )$$

Four pairs of transforms

$${G}_{1}^{′} and {G}_{2}^{′}$$

may be determined as shown below:

$$[ \begin{matrix}{G}_{1}^{′} \\ {G}_{2}^{′}\end{matrix} ] = \frac{1}{\sqrt{{w}_{1} + {w}_{2}}} [ \begin{matrix}\sqrt{{w}_{1}} & - \sqrt{{w}_{2}} \\ \sqrt{{w}_{2}} & \sqrt{{w}_{1}}\end{matrix} ]$$

Since the RAHT transform matrix is a normal matrix, the RAHT inverse transform is the transpose of RAHT transform matrix.

Step 2 (1004) prepares RAHT weight pairs along the y-direction for the RAHT and RAHT inverse transforms. Four weights are computed as shown below:

$${w}_{x , 2 y , 2 z} = {w}_{2 x , 2 y , 2 z} + {w}_{2 x + 1 , 2 y , 2 z}$$

$${w}_{x , 2 y + 1 , 2 z} = {w}_{2 x , 2 y + 1 , 2 z} + {w}_{2 x + 1 , 2 y + 1 , 2 z}$$

$${w}_{x , 2 y , 2 z + 1} = {w}_{2 x , 2 y , 2 z + 1} + {w}_{2 x + 1 , 2 y , 2 z + 1}$$

$${w}_{x , 2 y + 1 , 2 z + 1} = {w}_{2 x , 2 y + 1 , 2 z + 1} + {w}_{2 x + 1 , 2 y + 1 , 2 z + 1}$$

Two pairs of weights are formed from the four weights:

$$( {w}_{1} , {w}_{2} ) = ( {w}_{x , 2 y , 2 z} , {w}_{x , 2 y + 1 , 2 z} )$$

$$( {w}_{1} , {w}_{2} ) = ( {w}_{x , 2 y , 2 z + 1} , {w}_{x , 2 y + 1 , 2 z + 1} )$$

Two pairs of transforms

$${G}_{1}^{′} and {G}_{2}^{′}$$

may be determined as shown below:

$$[ \begin{matrix}{G}_{1}^{′} \\ {G}_{2}^{′}\end{matrix} ] = \frac{1}{\sqrt{{w}_{1} + {w}_{2}}} [ \begin{matrix}\sqrt{{w}_{1}} & - \sqrt{{w}_{2}} \\ \sqrt{{w}_{2}} & \sqrt{{w}_{1}}\end{matrix} ]$$

Step 3 (1006) prepares RAHT weight pairs along the z-direction for the RAHT and RAHT inverse transforms. Two weights are computed as shown below:

$$\begin{matrix}{w}_{x , y , 2 z} = {w}_{x , 2 y , 2 z} + {w}_{x , 2 y + 1 , 2 z} \\ {w}_{x , y , 2 z + 1} = {w}_{x , 2 y , 2 z + 1} + {w}_{x , 2 y + 1 , 2 z + 1}\end{matrix}$$

A pair of weights is formed from the two weights:

$$( {w}_{1} , {w}_{2} ) = ( {w}_{x , 2 y , 2 z} + {w}_{x , y , 2 z + 1} )$$

A pair of transforms

$${G}_{1}^{′} and {G}_{2}^{′}$$

may be determined as shown below:

$$[ \begin{matrix}{G}_{1}^{′} \\ {G}_{2}^{′}\end{matrix} ] = \frac{1}{\sqrt{{w}_{1} + {w}_{2}}} [ \begin{matrix}\sqrt{{w}_{1}} & - \sqrt{{w}_{2}} \\ \sqrt{{w}_{2}} & \sqrt{{w}_{1}}\end{matrix} ]$$

To calculate the RAHT weights for the next octree level, the “final” weight (1008) is computed as shown below:

$${w}_{x , y , z} = {w}_{x , y , 2 z} + {w}_{x , y , 2 z + 1}$$

In some embodiments, the weights computed for the current octree level may be stored and used in the weight calculation for the next octree level. They may be discarded from memory after the weights for the next level are computed. The RAHT inverse transforms from all octree levels are stored to be used in the RAHT inverse transform.

### RAHT Decoding and Inverse Transform

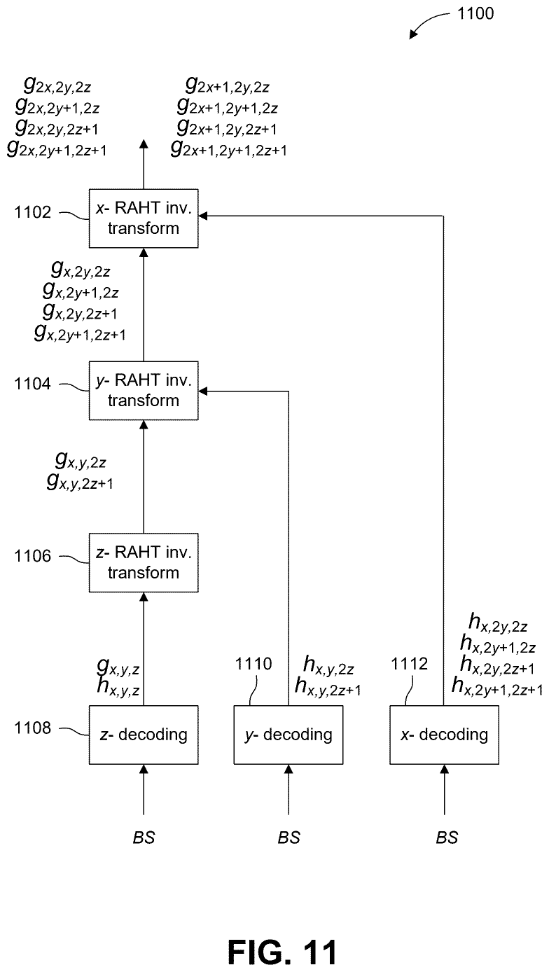

FIG. 11 is a process diagram illustrating an example RAHT inverse transform according to some embodiments. The second pass process 1100 decodes RAHT coefficients and performs a RAHT inverse transform, which starts from the root voxel and iterates for all octree levels in a top-down fashion, as shown in FIG. 11. For the root voxel, 1 DC coefficient g and 7 AC coefficients h are decoded. For the remaining octree-level voxels, only 7 AC coefficients are decoded. Each decoding block in FIG. 11 is composed of, in some embodiments, an arithmetic decoding step followed by a dequantization step. In this application, each decoding block 1108, 1110, 1112 in FIG. 11 corresponds to two blocks: “Feature Decoding” and “Reconstruction from Feature” in the decoders shown at the bottom of FIG. 4 and FIG. 5. The following steps apply to each occupied voxel at (x, y, z) from a current level to obtain the DC RAHT coefficients of the child level.

Step 1 (1106) is a z-RAHT inverse transform along the z-direction

The first AC coefficient is decoded by the z-direction decoding block 1108:

$${h}_{x , y , z}$$

Two RAHT inverse transforms,

$${G}_{x , y , 2 z}^{′} ( ) and {G}_{x , y , 2 z + 1}^{′} ( ) ,$$

are performed to compute two intermediate DC coefficients along the z-direction, as shown below:

$$\begin{matrix}{g}_{x , y , 2 z} = {G}_{x , y , 2 z}^{′} ( {g}_{x , y , z} , {h}_{x , y , z} ) \\ {g}_{x , y , 2 z + 1} = {G}_{x , y , 2 z + 1}^{′} ( {g}_{x , y , z} , {h}_{x , y , z} )\end{matrix}$$

Step 2 (1104) is a y-RAHT inverse transform along the y-direction.

The next two AC coefficients are decoded by the y-direction decoding block 1110:

$${h}_{x , y , 2 z} , {h}_{x , y , 2 z + 1}$$

Four RAHT inverse transforms,

$${G}_{x , 2 y , 2 z}^{′} ( ) , {G}_{x , 2 y + 1 , 2 z}^{′} ( ) , {G}_{x , 2 y , 2 z + 1}^{′} ( ) , and {G}_{x , 2 y + 1 , 2 z + 1}^{′} ( ) ,$$

are performed to compute 4 intermediate DC coefficients along the y-direction:

$$\begin{matrix}{g}_{x , 2 y , 2 z} = {G}_{x , 2 y , 2 z}^{′} ( {g}_{x , y , 2 z} , {h}_{x , y , 2 z} ) \\ {g}_{x , 2 y + 1 , 2 z} = {G}_{x , 2 y + 1 , 2 z}^{′} ( {g}_{x , y , 2 z} , {h}_{x , y , 2 z} ) \\ {g}_{x , 2 y + 2 z + 1} = {G}_{x , 2 y + 2 z + 1}^{′} ( {g}_{x , y , 2 z + 1} , {h}_{x , y , 2 z + 1} ) \\ {g}_{x , 2 y + 1 , 2 z + 1} = {G}_{x , 2 y + 1 , 2 z + 1}^{′} ( {g}_{x , y , 2 z + 1} , {h}_{x , y , 2 z + 1} )\end{matrix}$$

Step 3 (1102) is an x-RAHT inverse transform along the x-direction

The next 4 AC coefficients are decoded by the x-direction decoding block 1112:

$${h}_{x , 2 y , 2 z} , {h}_{x , 2 y + 1 , 2 z} , {h}_{x , 2 y , 2 z + 1} , {h}_{x , 2 y + 1 , 2 z + 1}$$

Eight RAHT inverse transforms,

$$\begin{matrix}{G}_{2 x , 2 y , 2 z}^{′} ( ) , {G}_{2 x + 1 , 2 y , 2 z}^{′} ( ) , {G}_{2 x , 2 y + 1 , 2 z}^{′} ( ) , {G}_{2 x + 1 , 2 y + 1 , 2 z}^{′} ( ) , {G}_{2 x , 2 y , 2 z + 1}^{′} ( ) , \\ {G}_{2 x + 1 , 2 y , 2 z + 1}^{′} ( ) , {G}_{2 x , 2 y + 1 , 2 z + 1}^{′} ( ) , and {G}_{2 x + 1 , 2 y + 1 , 2 z + 1}^{′} ( ) ,\end{matrix}$$

are performed to compute the 8 DC coefficients for the children:

$$\begin{matrix}{g}_{2 x , 2 y , 2 z} = {G}_{2 x , 2 y , 2 z}^{′} ( {g}_{x , 2 y , 2 z} , {h}_{x , 2 y , 2 z} ) \\ {g}_{2 x + 1 , 2 y , 2 z} = {G}_{2 x + 1 , 2 y , 2 z}^{′} ( {g}_{x , 2 y , 2 z} , {h}_{x , 2 y , 2 z} ) \\ {g}_{2 x , 2 y + 1 , 2 z} = {G}_{2 x , 2 y + 1 , 2 z}^{′} ( {g}_{x , 2 y + 1 , 2 z} , {h}_{x , 2 y + 1 , 2 z} ) \\ {g}_{2 x + 1 , 2 y + 1 , 2 z} = {G}_{2 x + 1 , 2 y + 1 , 2 z}^{′} ( {g}_{x , 2 y + 1 , 2 z} , {h}_{x , 2 y + 1 , 2 z} ) \\ {g}_{2 x , 2 y , 2 z + 1} = {G}_{2 x , 2 y , 2 z + 1}^{′} ( {g}_{x , 2 y , 2 z + 1} , {h}_{x , 2 y , 2 z + 1} ) \\ {g}_{2 x + 1 , 2 y , 2 z + 1} = {G}_{2 x + 1 , 2 y , 2 z + 1}^{′} ( {g}_{x , 2 y , 2 z + 1} , {h}_{x , 2 y , 2 z + 1} ) \\ {g}_{2 x , 2 y + 1 , 2 z + 1} = {G}_{2 x , 2 y + 1 , 2 z + 1}^{′} ( {g}_{x , 2 y + 1 , 2 z + 1} , {h}_{x , 2 y + 1 , 2 z + 1} ) \\ {g}_{2 x + 1 , 2 y + 1 , 2 z + 1} = {G}_{2 x + 1 , 2 y + 1 , 2 z + 1}^{′} ( {g}_{x , 2 y + 1 , 2 z + 1} , {h}_{x , 2 y + 1 , 2 z + 1} )\end{matrix}$$

In some embodiments, the RAHT inverse transform is computed and saved to a buffer during a bottom-up process that is finished before running the top-down RAHT inverse transform.

In some embodiments, only the RAHT weight is saved for each voxel computed in the bottom-up process if the memory to store all RAHT inverse transform is not wanted. In some embodiments, the calculation of all intermediate RAHT weights, e.g., w_{x,2y,2z} to w_{x,y,2z+1}, are repeated in the top-down pass to prepare the RAHT inverse transform. In other words, the process shown in FIG. 10 may be run twice for some embodiments. The first run is a bottom-up process that fills the RAHT weights for all octree voxels. The second run is a bottom-down process that computes the intermediate RAHT weights. Without running the bottom-up process, the weight calculation cannot be done in top-down process because top-down process needs to access the RAHT weights from a finer octree level. The additional computation overhead saves the memory used to store the RAHT inverse transforms.

Reconstruction from Features in RAHT Domain

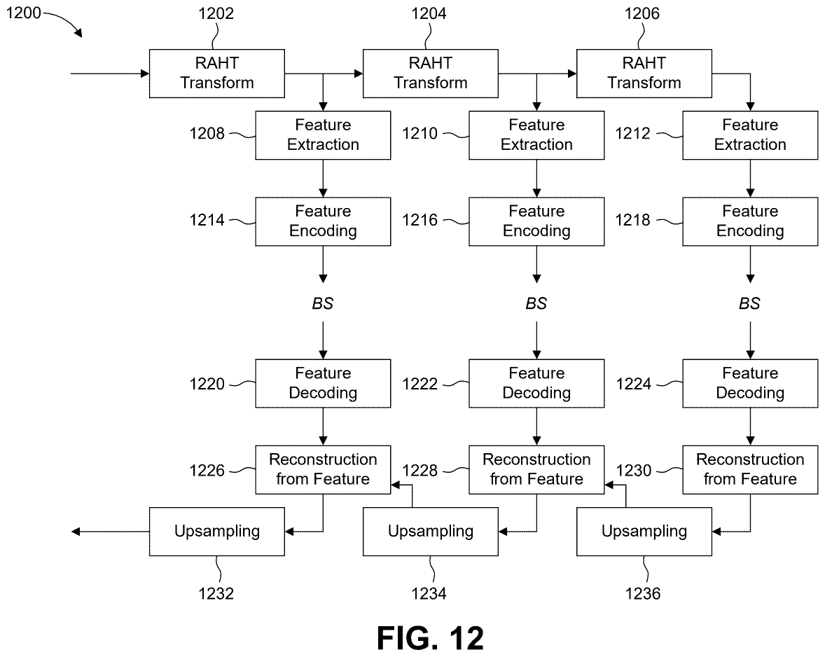

FIG. 12 is a process diagram illustrating an example RAHT domain learning based attribute coding framework reconstructing only RAHT DC coefficients at each level according to some embodiments.

This subsection describes how the “reconstruction from feature” process may be designed to be amenable with the “RAHT inverse transform” or “upsampling” blocks.

In some embodiments, when the encoder uses all 8 RAHT coefficients for feature extraction 1208, 1210, 1212 (whether in a single vector format or 8-vector format), the “reconstruction from feature” block 1226, 1228, 1230 on the decoder side is designed to output just the DC RAHT coefficient at each octree level. Moreover, the “RAHT inverse transform” block in this case is not required and an “upsampling” block 1232, 1234, 1236 is used, as shown in FIG. 12.

The diagram has a sequence of RAHT Transform blocks 1202, 1204, 1206 that represent the process to construct the octree structure of a point cloud. The process 1200 shown in FIG. 12 also has feature encoding blocks 1214, 1216, 1218 to feature encode the outputs of the feature extraction blocks 1208, 1210, 1212. On the decoder side, the bitstreams are passed through feature decoding blocks 1220, 1222, 1224, which output to the reconstruction from feature blocks 1226, 1228, 1230.

In some embodiments, when the RAHT DC coefficient is skipped on the encoder side (whether in a single vector format or 8-vector format), the corresponding “reconstruction from feature” on the decoder side is designed to output only the 7 AC RAHT coefficients at each octree level. Then, the DC coefficient of the current level is obtained from the preceding “RAHT inverse transform” of the parent level. The “RAHT inverse transform” at the current level combines all the RAHT coefficients at the current level to produce the RAHT DC coefficient for the child level. An example of this decoding pipeline is depicted in FIG. 5.

For some embodiments, an example method may include: decoding features representing RAHT coefficients corresponding to a point cloud frame at a current resolution; reconstructing the DC RAHT coefficient corresponding to the point cloud frame at the current resolution; and performing an upsampling process based on the reconstructed DC RAHT coefficient.

### Combination of Encoder/Decoder Architectures

The section below discusses some additional details for the overall process of learning-based attribute coding in the RAHT domain. In earlier subsections of this application, several embodiments for encoding and decoding are presented. Different combinations of encoding embodiments and decoding embodiments may be performed for some embodiments.

For some embodiments, all combinations to enable RAHT domain learning based attribute coding require the use of the encoder from FIG. 5, while the decoder may be either from FIG. 4 or FIG. 5.

For some embodiments, an encoder from FIG. 5 may be used to utilize a feature extractor on a single RAHT vector, paired with the decoder from FIG. 4 that reconstructs directly in the original RGB or YUV domain.

For some embodiments, an encoder from FIG. 5 may be used to utilize a feature extractor on a single RAHT vector, paired with the decoder from FIG. 5 that reconstructs only the DC RAHT coefficients at each level.

For some embodiments, an encoder from FIG. 5 may be used to utilize a feature extractor on a single RAHT vector, paired with the decoder from FIG. 5 that reconstructs only the AC RAHT coefficients at each level.

For some embodiments, an encoder from FIG. 5 may be used to utilize a feature extractor on 8 RAHT vectors, paired with the decoder from FIG. 4 that reconstructs directly in the original RGB or YUV domain.

Further embodiments are skipped for brevity.

### Training Considerations

To make the training less memory intensive and more efficient, the network may be trained in a stochastic manner. This means that during training, a level and a color channel (RGB or YUV) on which to train may be picked at random.

To perform the training at one octree level, the rate of the feature (denoted by R) may be estimated by the model used for entropy coding of the feature. The distortion loss (denoted by D) between the reconstructed attribute and its ground-truth value may be computed. The overall loss is given by L=D+λ·R, where λ is the R-D trade off parameter.

### Advanced Micro-Architectures

Previous sections of this application indicate that various learning-based blocks may be implemented through regular convolutions or sparse convolutions. In addition to these, advanced convolution-based and transformer-based architectures may be deployed to construct various blocks of the framework.

This application is understood to present a novel method to extract features for point cloud attributes. Instead of aggregating features based on attributes in the original color domain, a RAHT transform followed by a neural network-based feature extraction may be done. The features are encoded and sent to bitstreams. On the decoder side, the decoded RAHT coefficients are reconstructed from decoded features followed by a RAHT inverse transform to reconstruct the attributes in the original color domain.

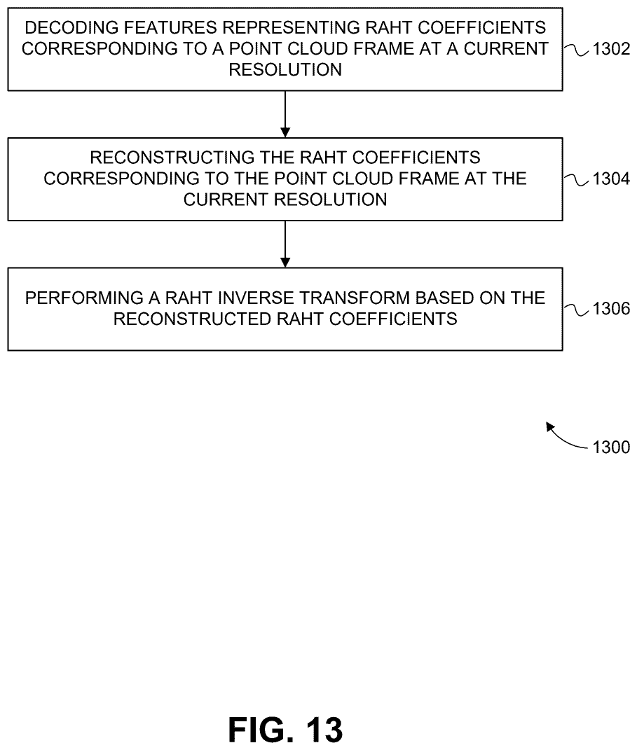

FIG. 13 is a flowchart illustrating an example decoding process according to some embodiments. For some embodiments, an example process 1300 may include decoding 1302 features representing RAHT coefficients corresponding to a point cloud frame at a current resolution. For some embodiments, the example process 1300 may further include reconstructing 1304 the RAHT coefficients corresponding to the point cloud frame at the current resolution. For some embodiments, the example process 1300 may further include performing 1306 a RAHT inverse transform based on the reconstructed RAHT coefficients.

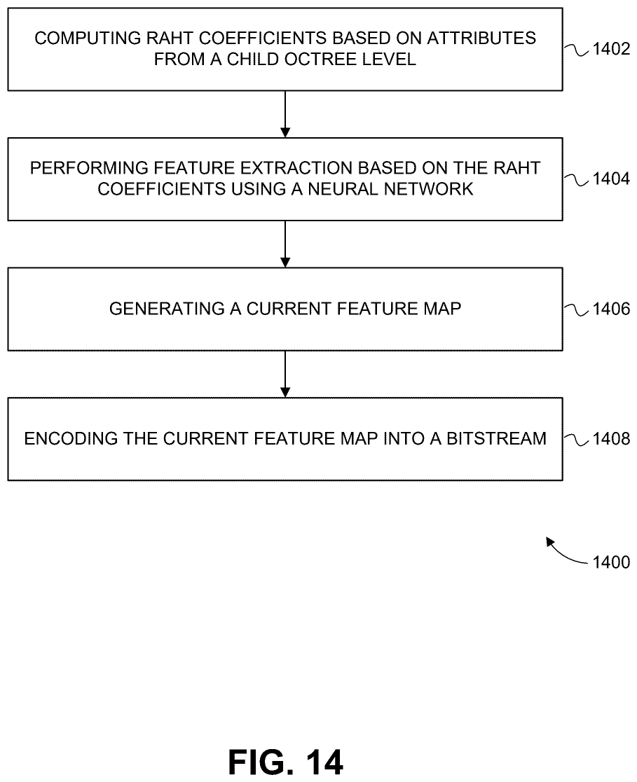

FIG. 14 is a flowchart illustrating an example encoding process according to some embodiments. For some embodiments, an example process 1400 may include computing 1402 RAHT coefficients based on attributes from a child octree level. For some embodiments, an example process 1400 may further include performing 1404 feature extraction based on the RAHT coefficients using a neural network. For some embodiments, an example process 1400 may further include generating 1406 a current feature map. For some embodiments, an example process 1400 may further include encoding 1408 the current feature map into a bitstream.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: decoding features representing RAHT coefficients corresponding to a point cloud frame at a current resolution; reconstructing the RAHT coefficients corresponding to the point cloud frame at the current resolution; and performing a RAHT inverse transform based on the reconstructed RAHT coefficients.

For some embodiments of the first example method, performing the RAHT inverse transform includes: performing a RAHT inverse transform along a z-direction; performing a RAHT inverse transform along a y-direction; and performing a RAHT inverse transform along an x-direction.

For some embodiments of the first example method, performing the RAHT inverse transform along the z-direction generates 2 intermediate DC coefficients; performing the RAHT inverse transform along the y-direction generates 4 intermediate DC coefficients; and performing the RAHT inverse transform along then x-direction generates 8 intermediate DC coefficients.

For some embodiments of the first example method, reconstructing the RAHT coefficients generates only a DC RAHT coefficient at the current resolution.

For some embodiments of the first example method, reconstructing the RAHT coefficients generates only AC RAHT coefficients at the current resolution.

Some embodiments of the first example method may further include obtaining a DC RAHT coefficient from a parent level RAHT inverse transform.

For some embodiments of the first example method, performing the RAHT inverse transform includes performing a bottom-up procedure to determine weights for the RAHT inverse transform.

For some embodiments of the first example method, performing the RAHT inverse transform includes combining the RAHT coefficients at the current resolution level to produce a RAHT DC coefficient for a child level.

Some embodiments of the first example method may further include obtaining an encoded bitstream corresponding to the point cloud frame.

A first example apparatus in accordance with some embodiments may include: a processor; and a memory storing instructions operative, when executed by the processor, to cause the apparatus to: decode features representing RAHT coefficients corresponding to a point cloud frame at a current resolution; reconstruct the RAHT coefficients corresponding to the point cloud frame at the current resolution; and perform a RAHT inverse transform based on the reconstructed RAHT coefficients.

A second example method in accordance with some embodiments may include: computing RAHT coefficients based on attributes from a child octree level; performing feature extraction based on the RAHT coefficients using a neural network; generating a current feature map; and encoding the current feature map into a bitstream.

For some embodiments of the second example method, performing feature extraction includes: concatenating the RAHT coefficients; and performing a convolutional neural network (CNN) process on the concatenated RAHT coefficients to extract features.

For some embodiments of the second example method, concatenating the RAHT coefficients includes generating an 8-dimensional RAHT map at the current resolution.

For some embodiments of the second example method, concatenating the RAHT coefficients includes generating a RAHT map at a resolution level higher than the current resolution.

For some embodiments of the second example method, the concatenated RAHT coefficients are used for each voxel at the current resolution.

For some embodiments of the second example method, concatenating the RAHT coefficients includes skipping a RAHT DC coefficient and using only RAHT AC coefficients for concatenating the RAHT coefficients.

For some embodiments of the second example method, computing the RAHT coefficients includes performing a RAHT transform on a point cloud frame.

For some embodiments of the second example method, performing the RAHT transform includes: performing a RAHT transform along a z-direction; performing a RAHT transform along a y-direction; and performing a RAHT transform along an x-direction.

For some embodiments of the second example method, computing the RAHT coefficients generates only a DC RAHT coefficient at the current resolution.

For some embodiments of the second example method, computing the RAHT coefficients generates only AC RAHT coefficients at the current resolution.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
decoding features representing Region-Adaptive Hierarchical Transform (RAHT) coefficients corresponding to a point cloud frame at a current resolution;
reconstructing the RAHT coefficients corresponding to the point cloud frame at the current resolution; and
performing a RAHT inverse transform based on the reconstructed RAHT coefficients.

2. The method of claim 1, wherein performing the RAHT inverse transform comprises:
performing a RAHT inverse transform along a z-direction;
performing a RAHT inverse transform along a y-direction; and
performing a RAHT inverse transform along an x-direction.

3. The method of claim 2,
wherein performing the RAHT inverse transform along the z-direction generates 2 intermediate DC coefficients;
wherein performing the RAHT inverse transform along the y-direction generates 4 intermediate DC coefficients; and
wherein performing the RAHT inverse transform along then x-direction generates 8 intermediate DC coefficients.

4. The method of claim 1, wherein reconstructing the RAHT coefficients generates only a DC RAHT coefficient at the current resolution.

5. The method of claim 1, wherein reconstructing the RAHT coefficients generates only AC RAHT coefficients at the current resolution.

6. The method of claim 5, further comprising obtaining a DC RAHT coefficient from a parent level RAHT inverse transform.

7. The method of claim 1, wherein performing the RAHT inverse transform comprises performing a bottom-up procedure to determine weights for the RAHT inverse transform.

8. The method of claim 1, wherein performing the RAHT inverse transform comprises combining the RAHT coefficients at the current resolution level to produce a RAHT DC coefficient for a child level.

9. The method of claim 1, further comprising obtaining an encoded bitstream corresponding to the point cloud frame.

10. An apparatus comprising:
a processor; and
a memory storing instructions operative, when executed by the processor, to cause the apparatus to:
decode features representing Region-Adaptive Hierarchical Transform (RAHT) coefficients corresponding to a point cloud frame at a current resolution;
reconstruct the RAHT coefficients corresponding to the point cloud frame at the current resolution; and
perform a RAHT inverse transform based on the reconstructed RAHT coefficients.

11. A method comprising:
computing Region-Adaptive Hierarchical Transform (RAHT) coefficients based on attributes from a child octree level;
performing feature extraction based on the RAHT coefficients using a neural network;
generating a current feature map; and
encoding the current feature map into a bitstream.

12. The method of claim 11, wherein performing feature extraction comprises:
concatenating the RAHT coefficients; and
performing a convolutional neural network (CNN) process on the concatenated RAHT coefficients to extract features.

13. The method of claim 12, wherein concatenating the RAHT coefficients comprises generating an 8-dimensional RAHT map at the current resolution.

14. The method of claim 12, wherein concatenating the RAHT coefficients comprises generating a RAHT map at a resolution level higher than the current resolution.

15. The method of claim 12, wherein the concatenated RAHT coefficients are used for each voxel at the current resolution.

16. The method of claim 12, wherein concatenating the RAHT coefficients comprises skipping a RAHT DC coefficient and using only RAHT AC coefficients for concatenating the RAHT coefficients.

17. The method of claim 11, wherein computing the RAHT coefficients comprises performing a RAHT transform on a point cloud frame.

18. The method of claim 11, wherein performing the RAHT transform comprises:
performing a RAHT transform along a z-direction;
performing a RAHT transform along a y-direction; and
performing a RAHT transform along an x-direction.

19. The method of claim 11, wherein computing the RAHT coefficients generates only a DC RAHT coefficient at the current resolution.

20. The method of claim 11, wherein computing the RAHT coefficients generates only AC RAHT coefficients at the current resolution.
